(19) United States
(12) Patent Application Publication
(10) Pub. No.: US 2024/0052145 A1
(43) Pub. Date: Feb. 15, 2024

(54) MULTIMODAL POLYETHYLENE

(71) Applicant: SABIC GLOBAL TECHNOLOGIES B.V., BERGEN OP ZOOM (NL)

(72) Inventors: Francisco Perez Valencia, Geleen (NL); Mark Johannes Boerakker, Eindhoven (NL)

(21) Appl. No.: 18/266,675

(22) PCT Filed: Dec. 6, 2021
(86) PCT No.: PCT/EP2021/084329

§ 371 Date: Jun. 12, 2023

(30) Foreign Application Priority Data
Dec. 11, 2020 (EP) 20213510.9

(51) Int. Cl. C08L 23/06; C08L 23/08; C08F 4/654

(52) U.S. Cl. CPC C08L 23/06; C08L 23/0815; C08F 4/6548; C08L 2205/025; C08L 2205/03; C08L 2314/02; C08L 2203/18; C08L 2203/16; C08L 2203/30

(57) ABSTRACT

An ethylene copolymer having a multimodal molecular mass distribution includes 40 to 80 wt % of an ethylene polymer component A, 5 to 40 wt % of an ethylene copolymer component B of ethylene and an olefin comonomer, having a higher molecular weight Mn than the ethylene homopolymer component A and having a molar comonomer content C_{B} and a density D_{B}, and 5 to 40 wt % of ethylene copolymer component C of ethylene and an olefin comonomer, having a higher molecular weight Mn than the ethylene copolymer component B and having a molar comonomer content C_{C} and a density D_{C}.

The amounts of A, B and C are based on the total weight of the ethylene polymer. The ethylene copolymer has a comonomer content of 0.10 to 3.00 mol % and the difference between C_{B} and C_{C} is at most 0.10 mol %.

### CROSS REFERENCE TO RELATED APPLICATIONS

This application is a National Stage application of PCT/EP2021/084329, filed Dec. 6, 2021, which claims the benefit of European Application No. 20213510.9, filed Dec. 11, 2020, both of which are incorporated by reference in their entirety herein.

### BACKGROUND

The present invention relates to a multimodal, preferably trimodal, ethylene copolymer and use of such ethylene copolymer in articles.

A trimodal ethylene copolymer is used in many application fields such as pipes.

WO2013079180 discloses a polyethylene composition for pipes comprising three ethylene homo- or copolymer fractions (A), (B) and (C) being different in their weight average molecular weight Mw. Fraction (A) is preferably an ethylene homopolymer. Fractions (B) and (C) are preferably ethylene copolymers. The preferred olefin comonomer is 1-hexene. In Inventive Example 1, a trimodal polyethylene consisting of 60 wt % of fraction (A), 21 wt % of fraction (B) and 19 wt % of fraction (C) was produced by a multi-reactor system. The comonomer content and the density of each of the fractions of the trimodal polyethylene of Inventive Example 1 are not mentioned. From the density of the polyethylene obtained from each of the reactors and the split of the fractions, it can be calculated that the density of the fraction (C) is substantially lower than the density of the fraction (B) and the comonomer content of the fraction (C) is higher than the comonomer content of the fraction (B).

WO2007022908 discloses a polyethylene composition for pipes comprising a low molecular weight ethylene homopolymer A, a high molecular weight ethylene copolymer B and an ultrahigh molecular weight ethylene copolymer C. In WO2007022908, preferably the ethylene copolymer B comprises 1 to 8 wt % of further olefin monomer units and the ethylene copolymer C comprises 1 to 8 wt % of further olefin monomer units. The preferred olefin comonomer is 1-butene. In Example 1, a trimodal polyethylene was produced by a multi-reactor system. The comonomer content and the density of each of the fractions of the trimodal polyethylene of Example 1 are not mentioned. From the volume amounts of ethylene and 1-butene measured in the gas phase of each reactor, it can be calculated that the comonomer content of the ethylene copolymer C is higher than the comonomer content of the ethylene copolymer B in Example 1.

Resistance to slow crack growth as indicated by a high strain hardening is important for many applications including pipes. Impact properties, processability, melt strength, sagging resistance, density, stiffness are also important. While known polyethylene is satisfactory for some applications, there is an ongoing need to provide an ethylene copolymer which has a combination of a high strain hardening modulus and other mechanical properties.

### SUMMARY

It is an objective of the present invention to provide an ethylene polymer in which the above-mentioned and/or other needs are met.

Accordingly, the present invention provides an ethylene copolymer having a multimodal molecular mass distribution, which comprises or consists of
40 to 80 wt % of an ethylene polymer component A,
5 to 40 wt % of an ethylene copolymer component B of ethylene and an olefin comonomer, having a higher molecular weight Mn than the ethylene homopolymer component A and having a molar comonomer content C_{B} and a density D_{B}, and
5 to 40 wt % of ethylene copolymer component C of ethylene and an olefin comonomer, having a higher molecular weight Mn than the ethylene copolymer component B and having a molar comonomer content C_{C} and a density D_{C},
wherein the amounts of A, B and C are based on the total weight of the ethylene copolymer, wherein
the ethylene copolymer has a comonomer content of 0.10 to 3.00 mol % and
the difference between C_{B} and C_{C} is at most 0.10 mol %.

### BRIEF DESCRIPTION OF THE DRAWINGS

FIG. 1 shows MWD of polymer component A;

FIG. 2 shows MWD and SCBD of polymer components B and D;

FIG. 3 shows MWD and SCBD of polymer components C and E; and

FIG. 4 shows MWD and SCBD of ethylene copolymer of Example 1 and comparative experiment 2.

### DETAILED DESCRIPTION

It was surprisingly found according to the invention that the similar comonomer contents between the copolymer components B and C result in a high strain hardening modulus. Compared to a multimodal ethylene copolymer having a similar overall comonomer content and a similar MWD with different comonomer contents among its components, the ethylene copolymer according to the invention was surprisingly found to have a higher strain hardening modulus while maintaining other mechanical properties.

The ethylene copolymer according to the invention is preferably a trimodal ethylene copolymer, i.e. it consists of components A, B and C. However, the ethylene copolymer according to the invention may comprise one or more further ethylene polymer components.

In other words, an ethylene copolymer comprising a component which satisfies the definition of component A in the required amount, a component which satisfies the definition of component B in the required amount and component which satisfies the definition of component C in the required amount, wherein the relationship between components A, B and C is satisfied, is considered as the ethylene copolymer according to the invention even if the ethylene copolymer comprises one or more further ethylene polymer components.

When present, the further ethylene polymer component is preferably an ethylene homopolymer. Preferably, the total amount of components A, B and C with respect to the ethylene copolymer according to the invention is at least 60 wt %, at least 70 wt %, at least 80 wt %, at least 90 wt %, at least 95 wt %, at least 98 wt % or at least 99 wt %.

### Ethylene Copolymer

By ethylene copolymer is meant a polymer the majority by weight of which derives from ethylene monomer units. The comonomer in the ethylene copolymer according to the invention may be selected from C3-C20 α-olefins, more preferably C3-10 α-olefins, more preferably selected from groups consisting of propylene, 1-butene, 1-hexene and 1-octene, most preferably 1-butene and/or 1-hexene.

Preferably, the ethylene copolymer according to the invention is high density polyethylene.

Preferably, the ethylene copolymer according to the invention has a density of 920 to 970 kg/m3, preferably 940 to 960 kg/m³.

5 The ethylene copolymer according to the invention has a melt flow index as measured according to ISO1133-1:2011 at 190° C. and 5 kg (herein sometimes referred as MI5) of 0.05 to 20 dg/min. The MI5 of the ethylene copolymer according to the invention may be 0.05 to 2.0 dg/min, which is particularly suitable for use in making a pipe or a film. The MI5 of the ethylene copolymer according to the invention may be 0.05 to 5.0 dg/min, which is particularly suitable for use in blow moulding. The MI5 of the ethylene copolymer according to the invention may be 1.0 to 20 dg/min, which is particularly suitable for use in injection moulding.

Preferably, the ethylene copolymer according to the invention has a melt flow index as measured according to ISO1133-1:2011 at 190° C. and 21.6 kg (herein sometimes referred as MI21.6) of 1.0 to 500 dg/min. The MI21.6 of the ethylene copolymer according to the invention may be 1.0 to 50 dg/min, which is particularly suitable for use in making a pipe or a film. The MI21.6 of the ethylene copolymer according to the invention may be 1.0-125 dg/min, which is particularly suitable for use in blow moulding. The MI21.6 of the ethylene copolymer according to the invention may be 20 to 500 dg/min, which is particularly suitable for use in injection moulding.

### Process for Preparation of Ethylene Copolymer

The ethylene copolymer according to the invention may be prepared by a process comprising melt-mixing or solution blending the components A, B and C and optional further ethylene polymer component(s) made in different reactors to obtain the ethylene copolymer. The melt-mixing or solution blending may be carried out in any conventional blending apparatus. The components A, B and C and optional further ethylene polymer component(s) to be melt-mixed or solution blended may be produced by any known process.

Alternatively, the ethylene copolymer according to the invention may be prepared by a process comprising polymerizing component A, subsequently polymerizing component B in the presence of component A and subsequently polymerizing component C in the presence of component A and B. Accordingly, the invention provides a process for the preparation of the ethylene copolymer according to the invention, wherein the process comprises a sequential polymerization process comprising at least three reactors connected in series, wherein said process comprises the steps of
preparing component A in a first reactor using the first set of conditions,
transferring said component A and unreacted monomers of the first reactor to a second reactor,
feeding monomers to said second reactor,
preparing component B in said second reactor in the presence of said component A,
transferring said components A and B and unreacted monomers of the second reactor to a third reactor,
feeding monomers to said third reactor,
preparing component C in said third reactor in the presence of said components A and B.

In such a case, the properties of the fractions produced in the second reactor and in the third reactor can either be inferred from polymers, which are separately produced in a single stage by applying identical polymerisation conditions (e.g. identical temperature, partial pressures of the reactants/diluents, suspension medium, reaction time) with regard to the stage of the multistage process in which the fraction is produced, and by using a catalyst on which no previously produced polymer is present. Alternatively, the properties of the fractions produced in a higher stage of the multistage process may also be calculated, e.g. in accordance with B. Hagström, Conference on Polymer Processing (The Polymer Processing Society), Extended Abstracts and Final Programme, Gothenburg, Aug. 19 to 21, 1997, 4:13. The properties of the fractions produced in a higher stage of the multistage process may also be calculated K. B. McAuley, J. F. McGregor, AIChE Journal, vol. 37, No. 6, 825-835, June 1991.

Thus, although not directly measurable on the multistage process products, the properties of the fractions produced in higher stages of such a multistage process can be determined by applying either or both of the above methods. The skilled person will be able to select the appropriate method.

### Ethylene Polymer Component A

Preferably, the ethylene polymer component A has a density D A of at least 954 kg/m³, preferably 965 to 982 kg/m³, more preferably 968 to 975 kg/m³.

Preferably, component A has a melt flow index as measured according to ISO1133-1:2011 at 190° C. and 1.2 kg of 0.5 to 500 dg/min, preferably 40 to 250 dg/min.

Preferably, component A has Mn of 2 to 50 kDa.

Preferably, component A has Mw of 4 to 150 kDa.

Preferably, component A has Mz of 20 to 4000 kDa.

Preferably, component A has Mw/Mn of 2 to 20.

Preferably, component A is an ethylene homopolymer. When component A is an ethylene copolymer, it may be a copolymer of ethylene and a comonomer selected from C3-C20 α-olefins, more preferably C3-10 α-olefins, more preferably selected from groups consisting of propylene, 1-butene, 1-hexene and 1-octene, most preferably 1-butene and/or 1-hexene. Preferably, the amount of the comonomer units in the ethylene polymer A is less than 0.1 mol %.

The amount of component A with respect to the ethylene copolymer according to the invention is 40 to 80 wt %, preferably 45 to 60 wt %.

### Ethylene Copolymer Component B

Preferably, the ethylene copolymer component B has a density D_{B} of 910 to 940 kg/m3, preferably 925 to 935 kg/m3.

Preferably, component B has a melt flow index as measured according to ISO1133-1:2011 at 190° C. and 21.6 kg of 0.01 to 50.0 dg/min, more preferably 0.1 to 5.0 dg/min.

Preferably, component B has Mn of 15 to 300 kDa. Preferably, Mn of component B is at least 20 kDa, for example 30 to 100 kDa, higher than Mn of component A.

Preferably, component B has Mw of 100 to 1000 kDa. Preferably, Mw of component B is at least 100 kDa, for example 300 to 500 kDa, higher than Mw of component A.

Preferably, component B has Mz of 170 to 7000 kDa.

Preferably, component B has Mw/Mn of 2 to 10.

In some embodiments, component B has Mn of 15 to 300 kDa, Mw of 200 to 1000 kDa, Mz of 350 to 7000 kDa and/or Mw/Mn of 2 to 10. These ranges of Mn, Mw, Mz and Mw/Mn are particularly suitable when the ethylene copolymer according to the invention is used for making a pipe or a film.

In some embodiments, component B has Mn of 15 to 300 kDa, Mw of 150 to 1000 kDa, Mz of 250 to 7000 kDa and/or Mw/Mn of 2 to 10. These ranges of Mn, Mw, Mz and Mw/Mn are particularly suitable when the ethylene copolymer according to the invention is used for blow moulding.

In some embodiments, component B has Mn of 15 to 300 kDa, Mw of 100 to 700 kDa, Mz of 170 to 5000 kDa and/or Mw/Mn of 2 to 10. These ranges of Mn, Mw, Mz and Mw/Mn are particularly suitable when the ethylene copolymer according to the invention is used for injection moulding.

Component B is an ethylene copolymer of ethylene and a comonomer selected from C3-C20 α-olefins, more preferably C3-10 α-olefins, more preferably selected from groups consisting of propylene, 1-butene, 1-hexene and 1-octene, most preferably 1-butene and/or 1-hexene.

Preferably, the comonomer content C_{B} of component B is 0.10 to 5.00 mol %, more preferably 0.50 to 3.00 mol %, more preferably 0.75 to 1.50 mol %.

The amount of component B with respect to the ethylene polymer according to the invention is 5 to 40 wt %, preferably 10 to 30 wt %.

### Ethylene Copolymer Component C

Preferably, the ethylene copolymer component C has a density D_{C} of 910 to 940 kg/m³, preferably 920 to 930 kg/m³. The difference between D_{B} and D_{C} is at most 10 kg/m3, preferably at most 5.0 kg/m³. D_{B} may be lower than D_{C}, but preferably, D_{B} is higher than or equal to D_{C}.

Preferably, component C has a melt flow index as measured according to ISO1133-1:2011 at 190° C. and 21.6 kg of 0.01 to 50.0 dg/min, more preferably 0.05 to 2.0 dg/min.

Preferably, component C has Mn of 30 to 400 kDa. Preferably, Mn of component C is at least 10 kDa, for example 15 to 30 kDa, higher than Mn of component B.

Preferably, component C has Mw of 170 to 1200 kDa. Preferably, Mw of component C is at least 20 kDa, for example 30 to 100 kDa, higher than Mw of component B.

Preferably, component C has Mz of 300 to 10000 kDa.

Preferably, component C has Mw/Mn of 2 to 10.

In some embodiments, component C has Mn of 30 to 400 kDa, Mw of 350 to 1200 kDa, Mz of 500 to 10000 kDa and/or Mw/Mn of 2 to 10. These ranges of Mn, Mw, Mz and Mw/Mn are particularly suitable when the ethylene copolymer according to the invention is used for making a pipe or a film.

In some embodiments, component C has Mn of 30 to 400 kDa, Mw of 200 to 1200 kDa, Mz of 400 to 10000 kDa and/or Mw/Mn of 2 to 10. These ranges of Mn, Mw, Mz and Mw/Mn are particularly suitable when the ethylene copolymer according to the invention is used for blow moulding.

In some embodiments, component C has Mn of 30 to 400 kDa, Mw of 170 to 1000 kDa, Mz of 300 to 8000 kDa and/or Mw/Mn of 2 to 10. These ranges of Mn, Mw, Mz and Mw/Mn are particularly suitable when the ethylene copolymer according to the invention is used for injection moulding.

Component C is an ethylene copolymer of ethylene and a comonomer selected from C3-C20 α-olefins, more preferably C3-10 α-olefins, more preferably selected from groups consisting of propylene, 1-butene, 1-hexene and 1-octene, most preferably 1-butene and/or 1-hexene.

Preferably, the comonomer content C_{C} of component C is 0.10 to 5.00 mol %, more preferably 0.50 to 3.00 mol %, more preferably 0.75 to 1.50 mol %. The difference between C_{B} and C_{C} is at most 0.10 mol %, more preferably at most 0.05 mol %, more preferably at most 0.03 mol %. C_{C} may be higher than C_{B}, but preferably, C_{B} is lower than or equal to C_{C}.

The amount of component C with respect to the ethylene polymer according to the invention is 5 to 40 wt %, preferably 10 to 30 wt %.

### Catalyst

Each of the ethylene polymer components A, B and C and the optional further ethylene polymer component(s) may be produced in the presence of known catalyst systems such as a Ziegler Natta catalyst system or a metallocene catalyst system, preferably a Ziegler Natta catalyst system. The polymerization can be carried out in the presence of an anti-static agent or anti fouling agent in an amount ranging between for example 1 and 500 ppm related to the total amount of reactor contents.

Preferably, the catalyst system comprises
(I) the solid reaction product obtained by reaction of:
   a) a hydrocarbon solution containing
      1) an organic oxygen containing magnesium compound or a halogen containing magnesium compound and
      2) an organic oxygen containing titanium compound and
   b) an aluminium halogenide having the formula AlRₙX₃₋ₙ in which R is a hydrocarbon moiety containing 1-10 carbon atoms, X is halogen and 0<n<3 and

(II) an aluminium compound having the formula AlR₃ in which R is a hydrocarbon moiety containing 1-10 carbon atoms.

During the reaction of the hydrocarbon solution comprising the organic oxygen containing magnesium compound and the organic oxygen containing titanium compound with component (I b) a solid catalyst precursor precipitates and after the precipitation reaction the resulting mixture is heated to finish the reaction.

The aluminium compound (II) is dosed prior to or during the polymerization and may be referred to as a cocatalyst.

The polymerisation process may be a slurry polymerisation process.

Preferably, the diluent in the slurry polymerisation process is a diluent consisting of aliphatic hydrocarbon compounds that displays an atmospheric boiling temperature of at least 35° C., more preferred above 55° C. Suitable diluent is hexane and heptane. The preferred diluent is hexane.

Suitable organic oxygen containing magnesium compounds include for example magnesium alkoxides such as magnesium methylate, magnesium ethylate and magnesium isopropylate and alkylalkoxides such as magnesium ethylethylate and so called carbonized magnesiumalkoxide such as magnesium ethyl carbonate. Preferably, the organic oxygen containing magnesium compound is a magnesium alkoxide. Preferably the magnesium alkoxide is magnesium ethoxide Mg(OC₂H₃)₂.

Suitable halogen containing magnesium compounds include for example magnesium dihalides and magnesium dihalide complexes wherein the halide is preferably chlorine.

Preferably the hydrocarbon solution comprises an organic oxygen containing magnesium compound as (I) (a) (1).

Suitable organic oxygen containing titanium compound may be represented by the general formula [TiOₓ(OR)₄₋₂ₓ]ₙ in which R represents an organic moiety, x ranges between 0 and 1 and n ranges between 1 and 6.

Suitable examples of organic oxygen containing titanium compounds include alkoxides, phenoxides, oxyalkoxides, condensed alkoxides, carboxylates and enolates. Preferably the organic oxygen containing titanium compounds is a titanium alkoxide. Suitable alkoxides include for example Ti(OC₂H₃)₄, Ti(OC₃H₇)₄, TiOC₄H₉)₄ and Ti(OC₈H₁₇)₄. Preferably the organic oxygen containing titanium compound is Ti(OC₄H₉)₄.

Preferably the aluminium halogenide is a compound having the formula AlRₙX₃₋ₙ in which R is a hydrocarbon moiety containing 1-10 carbon atoms, X is halogen and 0.5<n<2. Suitable examples of the aluminium halogenide in (I) b having the formula AlRₙX₃₋ₙ include ethyl aluminium dibromide, ethyl aluminium dichloride, propyl aluminium dichloride, n-butyl aluminium dichloride, iso butyl aluminium dichloride, diethyl aluminium chloride, diisobutyl aluminium chloride. Preferably X is Cl. Preferably the organo aluminium halogenide in (I) b) is an organo aluminium chloride, more preferably the organo aluminium halogenide in (I) b) is chosen from ethyl aluminium dichloride, diethyl aluminium dichloride, isobutyl aluminium dichloride, diisobutyl aluminium chloride or mixtures thereof.

Generally the molar ratio of Al from I b): Ti from I a) 2 ranges between 3:1 and 16:1. According to a preferred embodiment of the invention the molar ratio of Al from I b): Ti from I a) 2 ranges between 6:1 and 10:1.

Suitable examples 1 of the cocatalyst of the formula AlR₃ include tri ethyl aluminium, tri isobutyl aluminium, tri-n-hexyl aluminium and tri octyl aluminium. Preferably the aluminium compound in (II) of the formula AlR₃ is tri ethyl aluminium or tri isobutyl aluminium.

The hydrocarbon solution of organic oxygen containing magnesium compound and organic oxygen containing titanium compound can be prepared according to procedures as disclosed for example in U.S. Pat. No. 4,178,300 and EP0876318. The solutions are in general clear liquids. In case there are any solid particles, these can be removed via filtration prior to the use of the solution in the catalyst synthesis.

Generally the molar ratio of magnesium:titanium is lower than 3:1 and preferably the molar ratio magnesium: titanium ranges between 0, 2:1 and 3:1.

Generally the molar ratio of aluminium from (II): titanium from (a) ranges between 1:1 and 300:1 and preferably the molar ratio of aluminium from (II): titanium from (a) ranges between 3:1 and 100:1.

The catalyst may be obtained by a first reaction between a magnesium alkoxide and a titanium alkoxide, followed by dilution with a hydrocarbon solvent, resulting in a soluble complex consisting of a magnesium alkoxide and a titanium alkoxide and thereafter a reaction between a hydrocarbon solution of said complex and the organo aluminium halogenide having the formula AlRₙX₃₋ₙ

Optionally an electron donor can be added either during the preparation of the solid catalytic complex (at the same time as the subsequent step or in an additional step) or at the polymerization stage. The addition of an electron donor is for example disclosed in WO2013087167.

Generally, the aluminium halogenide having the formula AlRₙX₃₋ₙ is used as a solution in a hydrocarbon. Any hydrocarbon that does not react with the organo aluminium halogenide is suitable to be applied as the hydrocarbon.

The sequence of the addition can be either adding the hydrocarbon solution containing the organic oxygen containing magnesium compound and organic oxygen containing titanium compound to the compound having the formula AlRₙX₃₋ₙ or the reversed.

The temperature for this reaction can be any temperature below the boiling point of the used hydrocarbon. Generally the duration of the addition is preferably shorter than 1 hour.

In the reaction of the hydrocarbon solution of the organic oxygen containing magnesium compound and the organic oxygen containing titanium compound with the organo aluminium halogenide of formula AlRₙX₃₋ₙ, the solid catalyst precursor precipitates. After the precipitation reaction the resulting mixture is heated for a certain period of time to finish the reaction. After the reaction the precipitate is filtered and washed with a hydrocarbon. Other means of separation of the solids from the diluents and subsequent washings can also be applied, like for example multiple decantation steps. All steps should be performed in an inert atmosphere of nitrogen or another suitable inert gas.

### Further Aspects

The present invention further relates to a composition comprising the ethylene polymer according to the invention. The composition may consist of the ethylene polymer according to the invention and additives such as pigments, nucleating agents, antistatic agents, fillers, antioxidants etc. The amount of the additives in the composition is generally up to 10% by weight, preferably up to 5% by weight of the composition.

The present invention further relates to an article comprising the ethylene polymer according to the invention or the composition according to the invention. Preferably, the article is selected from the group consisting of an extruded article such a pipe, a blow moulded article, a film and an injection moulded article.

It is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### Catalyst Preparation

100 grams of granular Mg(OC₂H₅)₂ and 150 millilitres of Ti(OC₄H₉)₄ were brought in a 2 litre round bottomed flask equipped with a reflux condenser and stirrer. While gently stirring, the mixture was heated to 180° C. and subsequently stirred for 1.5 hours. During this, a clear liquid was obtained. The mixture was cooled down to 120° C. and subsequently diluted with 1480 ml of hexane. Upon addition of the hexane, the mixture cooled further down to 67° C. The mixture was kept at this temperature for 2 hours and subsequently cooled down to room temperature. The resulting clear solution was stored under nitrogen atmosphere and was used as obtained. Analyses on the solution showed a titanium concentration of 0.25 mol/I.

In a 1.0 liters glass reactor, equipped with baffles, reflux condenser and stirrer, 286 ml hexanes and 170 ml of the complex from obtained above were dosed. The stirrer was set at 1400 rpm. In a separate flask, 75 ml of 50% ethyl aluminium dichloride (EADC) solution was added to 43 ml of hexanes. The resulting EADC solution was dosed into the reactor in 15 minutes using a peristaltic pump. Subsequently, the mixture was refluxed for 2 hours. After cooling down to ambient temperature, the obtained red/brown suspension was transferred to a glass P4 filter and the solids were separated. The solids were washed 4 times using 500 ml of hexanes. The solids were taken up in 0.3 L of hexanes and the resulting slurry was stored under nitrogen. The solid content was 30 g/l

### Catalyst Analysis Results:

Ti 9.7 wt % Mg 10.4 wt % Al 4.6 wt % Cl 49 wt % OEt 9.0 wt % and OBu 12 wt %

### Preparations of Ethylene Polymer Components

### Component A

Ethylene polymer component A was prepared using 40 mg of the catalyst prepared as above in a 20 L autoclave reactor using 10 liters of purified hexane as diluent. 8 mmol of TIBA was added to the 10 liters of purified hexane. The catalyst was added at the beginning of the polymerization. After catalyst injection, ethylene and hydrogen were continuously added to the reactor in order to keep total pressure and H2/C2 ratios constant throughout the polymerization. The polymerization was carried out at 85° C. and total pressure of 5.5 barg with a hydrogen to ethylene ratio in the headspace of the reactor of 3.0 mol/mol.

### Component B

Ethylene copolymer component B was prepared using 15 mg of the catalyst prepared as above in a 10 L autoclave reactor using 5 liters of purified hexane as diluent. 8 mmol of TIBA was added to the 5 liters of purified hexane. 80 ml of purified 1-hexene were added to the reactor. The catalyst was added at the beginning of the polymerization. After catalyst injection, ethylene and hydrogen were continuously added to the reactor in order to keep total pressure and H2/C2 ratios constant throughout the polymerization. The polymerization was carried out at 68° C. and total pressure of 1.0 barg with a hydrogen to ethylene ratio in the headspace of the reactor of 0.2 mol/mol.

### Component C

Ethylene copolymer component C was prepared using 15 mg of the catalyst prepared as above in a 20 L autoclave reactor using 10 liters of purified hexane as diluent. 8 mmol of TIBA was added to the 10 liters of purified hexane. 100 ml of purified 1-hexene were added to the reactor. The catalyst was added at the beginning of the polymerization. After catalyst injection, ethylene and hydrogen were continuously added to the reactor in order to keep total pressure and H2/C2 ratios constant throughout the polymerization. The polymerization was carried out at 78° C. and total pressure of 1.4 barg with a hydrogen to ethylene ratio in the headspace of the reactor of 0.034 mol/mol.

### Component D

Ethylene polymer component D was prepared using 15 mg of the catalyst prepared as above in a 10 L autoclave reactor using 5 liters of purified hexane as diluent. 8 mmol of TIBA was added to the 5 liters of purified hexane. 20 ml of purified 1-hexene were added to the reactor. The catalyst was added at the beginning of the polymerization. After catalyst injection, ethylene and hydrogen were continuously added to the reactor in order to keep total pressure and H2/C2 ratios constant throughout the polymerization. The polymerization was carried out at 78° C. and total pressure of 2.3 barg with a hydrogen to ethylene ratio in the headspace of the reactor of 0.17 mol/mol.

### Component E

Ethylene polymer component E was prepared using 15 mg of the catalyst prepared as above in a 20 L autoclave reactor using 10 liters of purified hexane as diluent. 8 mmol of TIBA was added to the 10 liters of purified hexane. 200 ml of purified 1-hexene were added to the reactor. The catalyst was added at the beginning of the polymerization. After catalyst injection, ethylene and hydrogen were continuously added to the reactor in order to keep total pressure and H2/C2 ratios constant throughout the polymerization. The polymerization was carried out at 78° C. and total pressure of 1.4 barg with a hydrogen to ethylene ratio in the headspace of the reactor of 0.03 mol/mol.

### Component F

Ethylene copolymer component F was prepared using 15 mg of the catalyst prepared as above in a 20 L autoclave reactor using 10 liters of purified hexane. 8 mmol of TIBA was added to the 10 liters of purified hexane. 14 ml of purified 1-hexene were added to the reactor. The catalyst was added at the beginning of the polymerization. After catalyst injection, ethylene and hydrogen were continuously added to the reactor in order to keep total pressure and H2/C2 ratios constant throughout the polymerization. The polymerization was carried out at 78 C and total pressure of 1.46 barg with a hydrogen to ethylene ratio in the headspace of the reactor of 0.11 mol/mol.

### Component G

Ethylene copolymer component G was prepared using 20 mg of the catalyst prepared as above in a 20 L autoclave reactor using 10 liters of purified hexane. 8 mmol of TIBA was added to the 10 liters of purified hexane. 225 ml of purified 1-hexene were added to the reactor. The catalyst was added at the beginning of the polymerization. After catalyst injection, ethylene and hydrogen were continuously added to the reactor in order to keep total pressure and H2/C2 ratios constant throughout the polymerization. The polymerization was carried out at 78 C and total pressure of 1.42 barg with a hydrogen to ethylene ratio in the headspace of the reactor of 0.056 mol/mol

Molecular weight, density, comonomer content and WI were measured for each component according to the methods described below and are summarized in table 1.

TABLE 1

| | | | | | | comonomer | |
|---|---|---|---|---|---|---|---|
| | Mn | Mw | Mz | | density | content | |
| | (kDa) | (kDa) | (kDa) | Mw/Mn | (kg/m3) | (mol %) | MI (dg/min) |
| A | 5 | 96 | 3700 | 18.5 | 972.4 | 0 | MI1.2 = 56.7 |
| B | 67 | 500 | 2100 | 7.5 | 930.7 | 0.94 | MI21.6 = 0.62 |
| D | 63 | 510 | 2100 | 8.1 | 941.6 | 0.15 | MI21.6 = 0.61 |
| C | 90 | 570 | 2000 | 6.3 | 926.7 | 0.95 | MI21.6 = 0.22 |
| E | 87 | 600 | 2100 | 6.8 | 920.8 | 1.69 | MI21.6 = 0.21 |
| F | | | | | 938.4 | 0.14 | MI21.6 = 0.23 |
| G | | | | | 924.5 | 1.69 | MI21.6 = 0.61 |

### Preparation of Trimodal Ethylene Polymer

### Example 1

11 grams of component A, 5.5 grams of component B and 5.5 grams of component C were dissolved in 2.5 liters of xylene with Di Tertiary Butyl Para-Cresol in a concentration of 5 g/liter of xylene. The mixture was stirred at 140° C. for 3 hours, after which the mixture was precipitated in methanol and dried under vacuum. After drying, 1500 ppm of Irganox 1010 and 1500 ppm of Irgafos 168 respective to the polymer amount were added to the material in 120 ml of acetone and 30 ml of heptane. The slurry was stirred at room temperature for 12 hours, followed by further evaporation under vacuum at 45 C for an extra 12 hours.

### Comparative Experiment 2

Example 1 was repeated except that 11 grams of component A, 5.5 grams of component D and 5.5 grams of component E were mixed.

### Comparative Experiment 3

Example 1 was repeated except that 11 grams of component A, 5.5 grams of component F and 5.5 grams of component G were mixed.

Molecular weight, density, comonomer content, MFI and strain hardening were measured for the compositions according to the methods described below and are summarized in table 2.

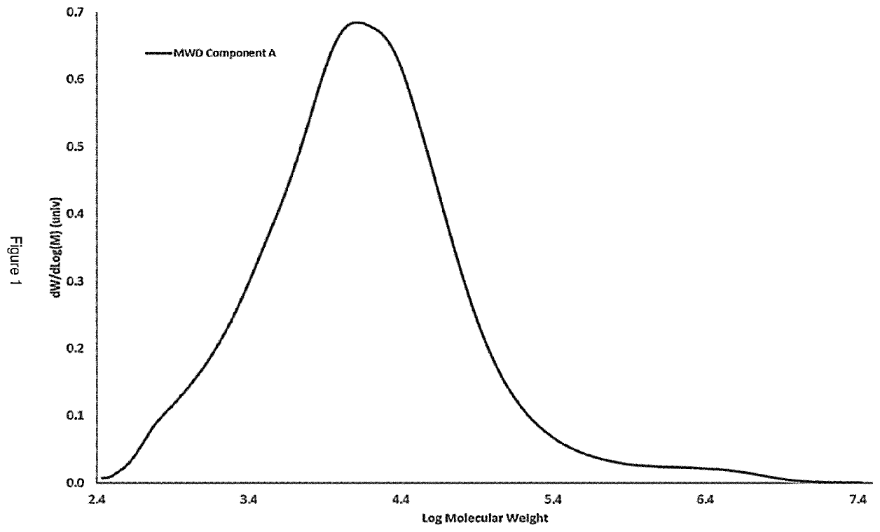

Further, FIG. 1 shows MWD of polymer component A;

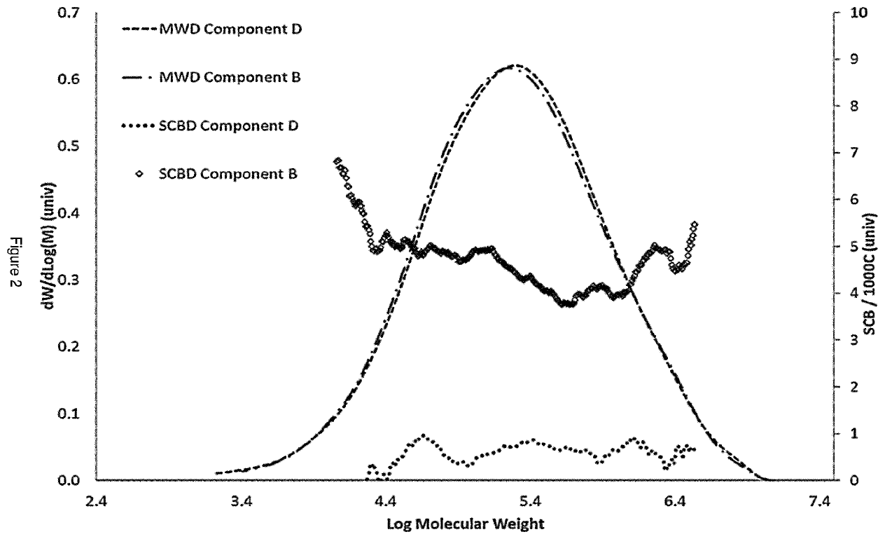

FIG. 2 shows MWD and SCBD of polymer components B and D;

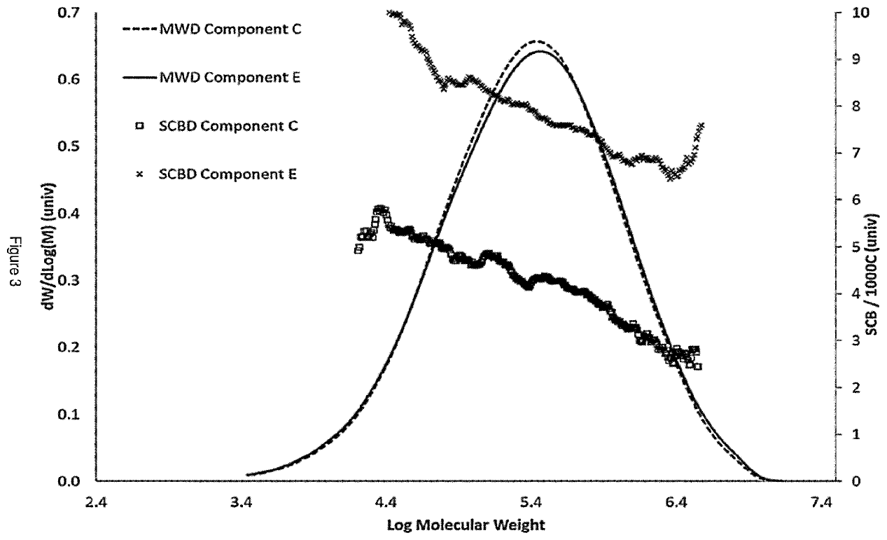

FIG. 3 shows MWD and SCBD of polymer components C and E;

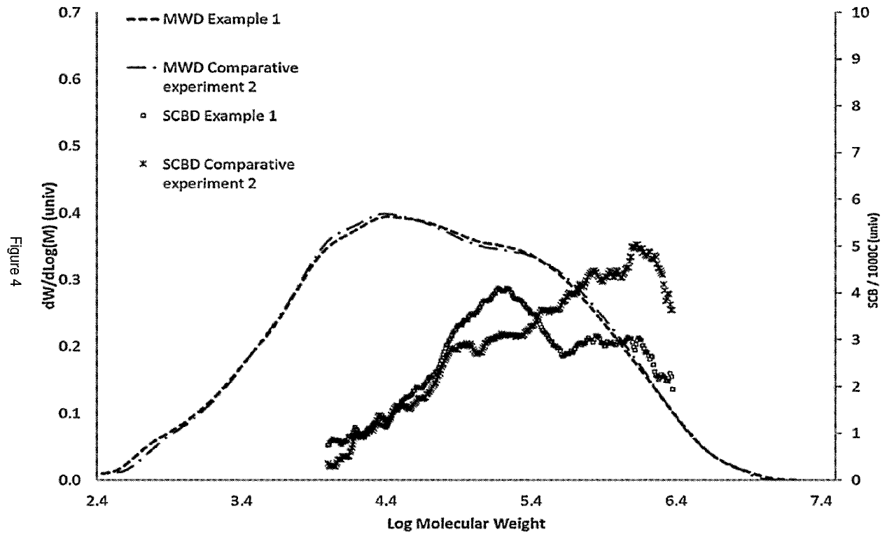

FIG. 4 shows MWD and SCBD of ethylene copolymer of Example 1 and comparative experiment 2.

TABLE 2

| | | | | | | | | Strain |
|---|---|---|---|---|---|---|---|---|
| | | | | | | | comonomer | Hardening |
| | components | Mn | Mw | Mz | | density | content | Modulus |
| | (weight ratio) | (kDa) | (kDa) | (kDa) | Mw/Mn | (kg/m³) | (mol %) | (MPa) |
| Ex 1 | A/B/C = 50/25/25 | 8 | 310 | 2200 | 37.4 | 950 | 0.47 | 47.3 |
| CEx 2 | A/D/E = 50/25/25 | 9 | 310 | 2000 | 33.9 | 951.3 | 0.46 | 44.8 |
| CEx 3 | A/G/F = 50/25/25 | | | | | | 0.43 | 40.3 |

The composition according to the invention wherein the comonomer contents and the density are similar between the components B and C (Ex 1) shows a higher strain hardening than the composition wherein the comonomer content is higher and the density is lower in the highest molecular weight component E (CEx 2) than the medium molecular weight component D.

The composition according to the invention wherein the comonomer contents and the density are similar between the components B and C (Ex 1) shows a higher strain hardening than the composition wherein the comonomer content is lower in the highest molecular weight component F (CEx 3) than the medium molecular weight component G.

From FIGS. 1-4, it can be understood that the molecular weight distribution and the total comonomer content are similar between Ex 1 and CEx 2. Accordingly, impact properties, processability, melt strength, sagging resistance and stiffness are expected to be similar between Ex 1 and CEx 2.

Accordingly, the composition according to the invention has a higher strain hardening while maintaining various other mechanical properties.

### Molecular Weight Distribution (MWD) and Moments of the MWD

Mw, Mn and Mz were measured in accordance with ASTM D6474-12 (Standard Test Method for Determining molecular weight distribution and molecular weight Averages of Polyolefins by High Temperature Gel Permeation Chromatography). Mw stands for the weight average molecular weight and Mn stands for the number average molecular weight. Mz stands for the z-average molecular weight.

A high-temperature chromatograph Polymer Char GPC-IR system equipped with IR5 MCT detector and Polymer Char viscometer (Polymer Char S.A., Spain) was used at 160° C. to determine the MWD and SCB as function of molecular weight. Three columns of Polymer Laboratories 13 μm PLgel Olexis, 300×7.5 mm, were used in series for GPC separation. 1,2,4-trichlorobenzene stabilized with 1 g/L butylhydroxytoluene (also known as 2,6-di-tert-butyl-4-methylphenol or BHT) was used as eluent at a flow rate of 1 mL/min. Sample concentration was around 0.7 mg/mL and injection volume was 300 μL. The molar mass was determined based on the Universal GPC-principle using a calibration made with PE narrow and broad standards (in the range of 0.5-2800 kg/mol, Mw/Mn—4 to 15) in combination with known Mark Houwink constants of PE-calibrant (alfa=0.725 and log K=−3.721).

### Density

Density of polymer components was measured by preparing polymer test plaques of 40×40×1.6 mm, following ISO 17855-2 in a Fontyne press model TP200. The compression cycle has a temperature set at 180 C, with 10 minutes of contact pressure. Cooling is performed with an initial time of 30 seconds without pressure increase, followed by pressure increase until 200 kN and maintaining the pressure level during the time needed for the sample to reach 23 C at a cooling rate of 15±2° C./min. Mass of the test plaque is determined in air (Analytical Balance XS104 Mettler Toledo). Subsequently, the test plaque is immersed in 4 liters of water at 100° C. (Automatic Densimeter D-H100 from Toyo Seiki equipped with a thermostatic bath MX7LR-20 from WMR) for 10 minutes after which the heat is turn off and the sample is cooled down to room temperature. The density is determined as follows:

$$\\ {ρ}_{s} = \frac{{m}_{s , air} \cdot {ρ}_{water}}{{m}_{s , air} - ( {m}_{s + nc , water} - {m}_{nc , water} )} + 0.0027$$

where:
ρₛ=Density of the test plaque (g/cm³)
m_{s,air}=Mass of the test plaque in air (g)
ρ_{water}=Density of demineralized water (g/cm³) at test temperature (23° C.)
m_{s+nc,water}=Mass of the test plaque and sinker in water (g)
m_{nc,water}=Mass of the sinker clamp in water (g)

Note: since density of polyethylene is lower than water, a sinker is used to keep the test plaque immersed.

Density of the copolymer was calculated from the density and the proportion of the polymer components.

### Comonomer Content

Samples were dissolved at 125° C. in C₂D₂Cl₄ containing DBPC as stabilizer. The ¹³C NMR spectra is recorded on a Bruker Avance500 NMR spectrometer equipped with a 10 mm cryogenically-cooled probe head operating at 125° C. Data is processed using Bruker Topspin 3.6.

### MFI

MFI was measured according to ISO 1133-1:2011 under a load of 1.2 kg (MI1.2) or 21.6 kg (MI21.6) at 190° C.

### Strain Hardening Modulus

Strain hardening was determined according to ISO18488.

### Short Chain Branching Distribution (SCBD)

An infrared detector (IR5 MCT, PolymerChar S.A., Spain) positioned at the exit of the GPC columns was used for quantification of the comonomer content in the polymer molecular weight fraction exiting the column, in number of Short Chain Branches per thousand carbon atoms (SCB/1000C). The content of SCB/1000C was determined by measuring the response on the IR band ratio (methyl over methylene absorbance) against a calibration of such signal with known samples in the range 1 to 75 SCB/1000C. In calculating the number of SCB/1000C from the total methyl ends per thousand carbon atoms, a correction is performed for the end groups, assuming two end groups per polymer chain.

1. An ethylene copolymer having a multimodal molecular mass distribution, which comprises
40 to 80 wt % of an ethylene polymer component A,
5 to 40 wt % of an ethylene copolymer component B of ethylene and an olefin comonomer, having a higher molecular weight Mn than the ethylene homopolymer component A and having a molar comonomer content C_{B} and a density D_{B}, and
5 to 40 wt % of ethylene copolymer component C of ethylene and an olefin comonomer, having a higher molecular weight Mn than the ethylene copolymer component B and having a molar comonomer content C_{C} and a density D_{C},
wherein the amounts of A, B and C are based on the total weight of the ethylene polymer, wherein
the ethylene copolymer has a comonomer content of 0.10 to 3.00 mol % and
the difference between C_{B} and C_{C} is at most 0.10 mol %.

2. The ethylene copolymer according to claim 1, wherein the ethylene copolymer has a density of 920 to 970 kg/m³, and/or a melt flow index as measured according to ISO1133-1:2011 at 190° C. and 5 kg of 0.05 to 20 dg/min, and/or a melt flow index as measured according to ISO1133-1:2011 at 190° C. and 21.6 kg of 1.0 to 500 dg/min.

3. The ethylene polymer according to claim 1, wherein the ethylene polymer component A has a density D_{A} of at least 954 kg/m³, and/or a melt flow index as measured according to ISO1133-1:2011 at 190° C. and 1.2 kg of 0.5 to 500 dg/min.

4. The ethylene polymer according to claim 1, wherein the ethylene copolymer component B has a density D_{B} of 910 to 940 kg/m³, and/or a melt flow index as measured according to ISO1133-1:2011 at 190° C. and 21.6 kg of 0.01 to 50.0 dg/min.

5. The ethylene polymer according to claim 1, wherein the ethylene copolymer component C has a density D_{C} of 910 to 940 kg/m³, and/or a melt flow index as measured according to ISO1133-1:2011 at 190° C. and 21.6 kg of 0.01 to 50.0 dg/min.

6. The ethylene polymer according to claim 1, wherein the ethylene polymer component A has Mw of 4 to 150 kDa, the ethylene copolymer component B has Mw of 100 to 1000 kDa and/or the ethylene copolymer component C has Mw of 170 to 1200 kDa.

7. The ethylene polymer according to claim 1, wherein the comonomer content C_{B} of component B is 0.10 to 5.00 mol %, and/or the comonomer content C_{C} of component C is 0.10 to 5.00 mol %.

8. The ethylene polymer according to claim 1, wherein the difference between D_{B} and D_{C} is at most 10.0 kg/m³.

9. The ethylene polymer according to claim 1, wherein the difference between C_{B} and C_{C} is at most 0.05 mol %.

10. The ethylene polymer according to claim 1, wherein the ethylene copolymer comprises one or more further ethylene polymer components.

11. A process for the preparation of the ethylene polymer according to claim 1, comprising melt-mixing or solution blending the components A, B and C, wherein each of components A, B and C is prepared by a slurry polymerisation process in the presence of a Ziegler Natta catalyst system.

12. A process for the preparation of the ethylene polymer according to claim 1, which is a multi-step slurry polymerisation process using cascaded reactors in the presence of a Ziegler Natta catalyst system.

13. The process according to claim 11, wherein the catalyst system comprises
(I) the solid reaction product obtained by reaction of:
a) a hydrocarbon solution containing
1) an organic oxygen containing magnesium compound or a halogen containing magnesium compound and
2) an organic oxygen containing titanium compound and
b) an aluminium halogenide having the formula AlRₙX₃₋ₙ in which R is a hydrocarbon moiety containing 1-10 carbon atoms, X is halogen and 0<n<3 and
(II) an aluminium compound having the formula AlR₃ in which R is a hydrocarbon moiety containing 1-10 carbon atoms.

14. A composition comprising the ethylene polymer according to claim 1 and additives.

15. An article comprising the ethylene polymer according to claim 1.

16. The ethylene polymer according to claim 10, wherein the total amount of the components A, B and C with respect to the ethylene copolymer is at least 60 wt %.
